(19) United States
(12) Patent Application Publication
(10) Pub. No.: US 2025/0290872 A1
(43) Pub. Date: Sep. 18, 2025

(54) WETNESS DETECTION SENSOR SHEET, WETNESS DETECTION SENSOR SHEET SET, AND WETNESS DETECTION SYSTEM

(71) Applicant: MEKTEC CORPORATION, Tokyo (JP)

(72) Inventor: Azumi TOMINAGA, Tokyo (JP)

(73) Assignee: MEKTEC CORPORATION, Tokyo (JP)

(21) Appl. No.: 19/004,200

(22) Filed: Dec. 27, 2024

(30) Foreign Application Priority Data
Mar. 12, 2024 (JP) 2024-037999

(51) Int. Cl. G01N 22/04; G08B 21/20; H04W 4/80

(52) U.S. Cl. CPC G01N 22/04; G08B 21/20; H04W 4/80

(57) ABSTRACT

Provided with a wetness detection sensor sheet, the wetness detection sensor sheet being configured to be worn by a wearer as part of or together with an absorbable product, including: a sensor device; and a water-conducting sheet, the sensor device includes an antenna portion and a communication portion, and is configured to be capable of wireless communication; the water-conducting sheet is placed on one or both sides of the sensor device in an overlapping manner, and is configured to extend from a stomach side to a back side through below a crotch of the wearer when the wearer wears the absorbable product; and the sensor device is provided on a side closer to a region of the water-conducting sheet corresponding to the stomach side or a region of the water-conducting sheet corresponding to the back side with respect to a region of the water-conducting sheet corresponding to below the crotch.

### CROSS-REFERENCE TO RELATED APPLICATION

This application claims priority from Japanese Patent Application No. 2024-037999 filed with the Japan Patent Office on Mar. 12, 2024, the entire content of which is hereby incorporated by reference.

### BACKGROUND

### 1. Technical Field

The present disclosure relates to a wetness detection sensor sheet, a wetness detection sensor sheet set, and a wetness detection system.

### 2. Related Art

There has been known a sensor having a wireless communication function and capable of detecting the wetness of an absorbable product such as a diaper.

JP-A-2021-38971 discloses a liquid detection sensor including a sheet board made using a material deformable in response to liquid, an antenna formed on the sheet board, and a communication circuit connected to the antenna to make wireless communication via the antenna.

JP-A-2020-165653 discloses a urination detecting tag including a base having moisture absorbency, loop-shaped wiring formed on the base and partially provided with a disconnected portion, a communication antenna formed on the base, and a detector connected to the wiring and the communication antenna to detect a wiring conduction state and transmit a detection result via the communication antenna in a contactless manner.

### SUMMARY

A wetness detection sensor sheet according to an embodiment of the present disclosure is a wetness detection sensor sheet, the wetness detection sensor sheet being configured to be worn as part of an absorbable product by a wearer or be worn together with the absorbable product by the wearer, including: a sheet-shaped sensor device; and a water-conducting sheet, in which the sensor device includes an antenna portion and a communication portion, and is configured to be capable of wireless communication; the water-conducting sheet is placed on one or both sides of the sensor device in an overlapping manner, and is configured to extend from a stomach side to a back side through below a crotch of the wearer when the wearer wears the absorbable product; and the sensor device is provided on a side closer to a region of the water-conducting sheet corresponding to the stomach side or a region of the water-conducting sheet corresponding to the back side with respect to a region of the water-conducting sheet corresponding to below the crotch.

### BRIEF DESCRIPTION OF THE DRAWINGS

FIG. 1 is a plan view showing an example of attachment of a wetness detection sensor sheet according to the present embodiment to an absorbable product;

FIG. 2 is a view schematically showing a multilayer structure of the wetness detection sensor sheet according to the present embodiment;

FIG. 3 is a partial end view of a sensor device;

FIG. 4 is a plan view of the sensor device when viewed from a wearer side:

FIG. 5 is a view selectively showing, when viewed from the wearer side, an antenna portion, a conductive wiring portion, and a communication portion of the sensor device;

FIG. 6 is a view selectively showing the conductive wiring portion of the sensor device when viewed from the wearer side;

FIG. 7 is a conceptual diagram showing a hardware configuration of a wetness detection system;

FIG. 8 is a conceptual diagram showing a software configuration of the wetness detection system;

FIG. 9 is an example of a wearer information table stored in a wearer management database;

FIG. 10 is a flowchart showing an operation example of the wetness detection system when wetness is checked; and

FIG. 11 is a flowchart showing an operation example of the wetness detection system when the absorbable product is worn or replaced.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the liquid detection sensor disclosed in JP-A-2021-38971, the sheet board deforms in response to liquid, and the characteristics of the antenna formed on the sheet board change or the antenna is broken accordingly. Such a state is detected on a wireless communication apparatus side, and in this manner, the wetness of the diaper is detected. Thus, this liquid detection sensor needs to be placed below the crotch of a diaper wearer such that urine reliably reaches the sheet board. Similarly, it is also assumed that the urination detecting tag disclosed in JP-A-2020-165653 is placed below the crotch of a diaper wearer.

However, when the liquid detection sensor is placed below the crotch, there are problems that the wearer not only feels discomfort due to a feeling of foreign body, but also that the wireless communication direction of the liquid detection sensor is limited.

One aspect of the present disclosure has been made in view of the above-described situation, and an object thereof is to provide a wetness detection sensor sheet, a wetness detection sensor sheet set, and a wetness detection system capable of reliably detecting the wetness of an absorbable product with a comfortable feeling of wearing.

The wetness detection sensor sheet according to the present disclosure is a wetness detection sensor sheet, the wetness detection sensor sheet being configured to be worn as part of an absorbable product by a wearer or be worn together with the absorbable product by the wearer, including: a sheet-shaped sensor device; and a water-conducting sheet, in which the sensor device includes an antenna portion and a communication portion, and is configured to be capable of wireless communication; the water-conducting sheet is placed on one or both sides of the sensor device in an overlapping manner, and is configured to extend from a stomach side to a back side through below a crotch of the wearer when the wearer wears the absorbable product; and the sensor device is provided on a side closer to a region of the water-conducting sheet corresponding to the stomach side or a region of the water-conducting sheet corresponding to the back side with respect to a region of the water-conducting sheet corresponding to below the crotch.

Further, a wetness detection sensor sheet set according to the present disclosure includes a plurality of the wetness detection sensor sheets of the present disclosure, in which the water-absorbing members of the plurality of the wetness detection sensor sheets included in the wetness detection sensor sheet set are each configured to have a different amount of water absorption at which the antenna portion or the conductive wiring portion of the sensor device is brought into the disconnection state.

A wetness detection system according to the present disclosure is a wetness detection system configured to be capable of wireless communication with the wetness detection sensor sheet of the present disclosure, including: a terminal communication section; a determination section; a display processing section; and a display device, in which the terminal communication section includes an antenna, and is configured to be capable of wireless communication with the sensor device via the antenna; the determination section is configured to determine wetness of the absorbable product according to a wireless communication state between the terminal communication section and the sensor device; when the wireless communication state indicates a specific wireless communication state corresponding to the disconnection state of the sensor device, the display processing section causes the display device to display an alert indication about a relationship between a position of the antenna and a position of the sensor device, relative to the absorbable product; and the determination section determines the wetness of the absorbable product according to user operation in response to the alert indication.

A wetness detection system according to the present disclosure includes the terminal communication section, determination section, information management section, and information storage section of the present disclosure, in which the terminal communication section is configured to be capable of wireless communication with the sensor device; the determination section is configured to determine wetness of the absorbable product according to a wireless communication between the terminal communication section and the sensor device; the information storage section is configured to store wearer identification information, wearing time information, sensor identification information, and positional information of the sensor device on the absorbable product for each wearer of the absorbable product; the sensor device has sensor identification information; the terminal communication section is configured to be capable of acquiring the sensor identification information from the sensor device via the wireless communication; and when the absorbable product is worn, the information management section identifies the wearer identification information on a wearer specified by user operation, causes the terminal communication section to acquire the sensor identification information from the sensor device, and stores, in the information storage section, the acquired sensor identification information, the wearing time information, and the positional information of the sensor device on the absorbable product in association with the identified wearer identification information.

According to the present disclosure, the wetness detection sensor sheet, the wetness detection sensor sheet set, and the wetness detection system can be provided, which are capable of reliably detecting the wetness of an absorbable product with a comfortable feeling of wearing.

Hereinafter, an embodiment of the present disclosure will be described. Note that the embodiment below is an example and the present disclosure is not limited to the configuration of the embodiment below.

First, the outline of the configuration of a wetness detection sensor sheet (hereinafter, may be referred to as a sensor sheet) according to the present embodiment will be described.

The present sensor sheet is worn as part of an absorbable product or worn together with the absorbable product, and is used for detecting the wetness of the absorbable product.

The “absorbable product” means a product capable of absorbing liquid, and for example, includes a disposable diaper, a urine absorbing pad, a sanitary pad, a pantyliner, and a toilet pad for pets. Note that the absorbable product whose wetness is detected by the present sensor sheet is not limited to these examples.

A “wearer” means a human or an animal (pet) wearing the absorbable product or the present sensor sheet.

The present sensor sheet may be incorporated as part of the absorbable product into the absorbable product in advance, or may be formed separately from the absorbable product and be attached to the absorbable product upon use. For example, when the absorbable product is a urine absorbing pad, the present sensor sheet may be housed in the urine absorbing pad, or may be attached onto the surface (surface facing the wearer side when the absorbable product is worn) of the urine absorbing pad or between the back surface of the urine absorbing pad and an underwear or a diaper at a position within the surface of the urine absorbing pad in plan view.

The present sensor sheet includes at least a sheet-shaped sensor device and a water-conducting sheet.

The water-conducting sheet is placed on one or both sides of the sensor device in an overlapping manner, and is provided so as to extend from the stomach side to the back side through below the crotch of the wearer when the absorbable product is worn. Preferably, when the absorbable product is worn, the water-conducting sheet is provided so as to extend from a specific stomach-side portion to a specific back-side portion through below the crotch of the wearer.

The “specific stomach-side portion” means a specific stomach-side portion of the wearer with respect to below the crotch of the wearer at an arbitrary position on the lower abdomen below the navel. For example, the specific stomach-side portion is in the vicinity of the bladder.

The “specific back-side portion” means a specific back-side portion of the wearer with respect to below the crotch of the wearer at an arbitrary position on the buttocks (hip). For example, the specific back-side portion is in the vicinity of the sacrum. The water-conducting sheet preferably has a length from the bladder position to the sacrum position through below the crotch on the body surface of an adult having a general physique.

The sensor device includes an antenna portion and a communication portion, and is configured to allow a detection apparatus to detect the wetness of the absorbable product via wireless communication.

The communication portion is a circuit for transmitting a radio wave with a predetermined frequency via the antenna portion, and for example, includes an IC chip for an RFID tag. The communication portion may include a power source, but preferably include no power source for cost reduction.

The sensor device is provided, in plan view, on the stomach side or the back side with respect to a region corresponding to below the crotch of the wearer in the longitudinal direction of the above-described water-conducting sheet. Specifically, the sensor device is provided in a region closer to a stomach-side end portion or a back-side end portion with respect to an under-crotch region corresponding to below the crotch of the wearer. The region closer to the stomach-side end portion with respect to the under-crotch region indicates a region within the stomach end portion and between the under-crotch region and the stomach-side end portion in the longitudinal direction on the side closer to the stomach-side end portion. Similarly, the region closer to the back-side end portion with respect to the under-crotch region indicates a region within the back-side end portion and between the under-crotch region and the back-side end portion on the side closer to the back-side end portion.

The under-crotch region of the water-conducting sheet is a region of the water-conducting sheet located below the crotch of the wearer, and has a predetermined area in the width direction and longitudinal direction of the water-conducting sheet such that a region of the wearer below the crotch thereof can be covered with the water-conducting sheet.

The stomach-side end portion and the back-side end portion of the water-conducting sheet are both end portions of the water-conducting sheet in the longitudinal direction, and are regions including certain areas from both ends in the longitudinal direction. The stomach-side end portion, the back-side end portion, and the under-crotch region do not overlap with each other.

As described above, in the present sensor sheet, the sensor device is provided in the region closer to the stomach-side end portion or the back-side end portion in the longitudinal direction with respect to the under-crotch region of the water-conducting sheet in plan view, and the water-conducting sheet is provided so as to extend from the specific stomach-side portion to the specific back-side portion through below the crotch of the wearer.

With this configuration, the sensor device is located on the stomach side or the back side with respect to below the crotch of the wearer when the absorbable product is worn, and therefore, as compared to a case where the sensor device is located below the crotch, an area where wireless the communication between the sensor device and the detection apparatus is available can be expanded and a wearer's feeling of foreign body and discomfort due to the sensor device can be reduced.

Further, the water-conducting sheet extending from the specific stomach-side portion to the specific back-side portion of the wearer can reliably guide liquid excreted from the wearer, such as urine, to the sensor device regardless of the gender or body position of the wearer, so that the wetness of the absorbable product can be reliably detected.

Hereinafter, details of the wetness detection sensor sheet according to the present disclosure will be described. Note that in the embodiment below, a case where the absorbable product is a urine absorbing pad and the wetness detection sensor sheet is attached to the surface (surface facing the wearer side when the absorbable product is worn) of the urine absorbing pad will be described as an example.

In the description below, the position and orientation of each component of the wetness detection sensor sheet and the absorbable product are those in a state in which the absorbable product is properly worn. Specifically, a side contacting the skin of the wearer may be referred to as a “wearer side”, the opposite side thereof may be referred to as an “outside/outer”, the right-left direction of the wearer may be referred to as a “right-left direction”, and the front-rear direction of the wearer may be referred to as a “front-rear direction”.

### Wetness Detection Sensor Sheet

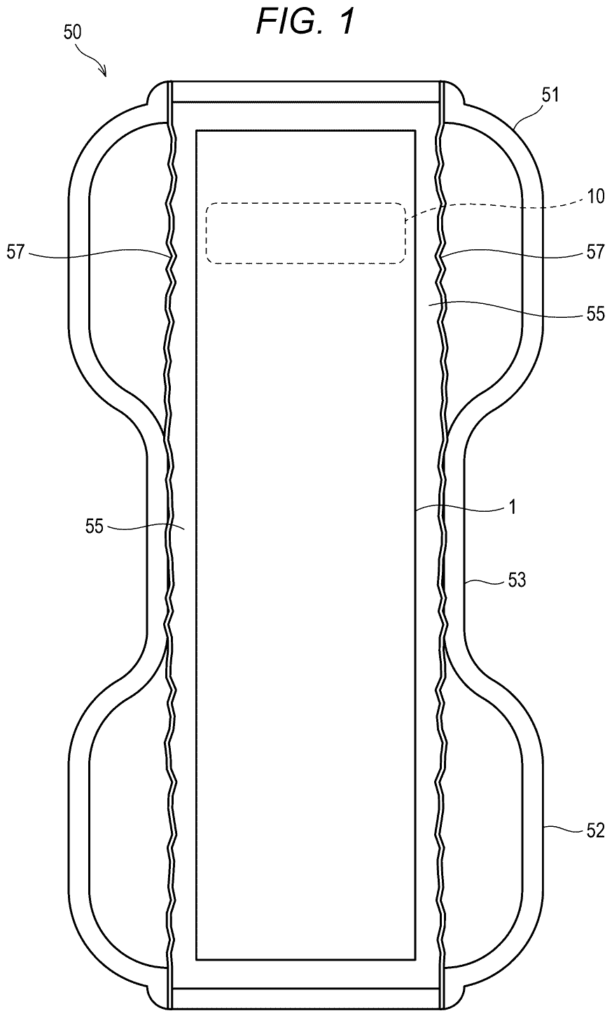

FIG. 1 is a plan view showing an example of attachment of a wetness detection sensor sheet 1 (hereinafter, may be referred to as a sensor sheet 1) according to the present embodiment to an absorbable product.

In the example of FIG. 1, the sensor sheet 1 is attached to a urine absorbing pad 50 which is the absorbable product. FIG. 1 shows the wearer-side surfaces of the sensor sheet 1 and the urine absorbing pad 50.

The urine absorbing pad 50 has a stomach-side portion 51, a back-side portion 52, and a coupling portion 53 coupling the stomach-side portion 51 and the back-side portion 52. The urine absorbing pad 50 is attached to the wearer-side surface of an underwear or a diaper, and is worn such that the stomach-side portion 51 is located on the stomach side of the wearer, the back-side portion 52 is located on the back side of the wearer, and the coupling portion 53 is located below the crotch of the wearer. The coupling portion 53 is located below the crotch of the wearer, and therefore, is formed narrower than the stomach-side portion 51 and the back-side portion 52.

The urine absorbing pad 50 has an absorber 55 on the wearer-side surface. The absorber 55 is configured to be capable of absorbing liquid excreted from the wearer, such as urine. The absorber 55 extends in the front-rear direction (longitudinal direction) over the stomach-side portion 51, the back-side portion 52, and the coupling portion 53. Further, the urine absorbing pad 50 has, at both end portions of the absorber 55 in the right-left direction (width direction), a pair of three-dimensional gathers 57 extending in the longitudinal direction of the absorber 55. These three-dimensional gathers 57 reduce leakage from the urine absorbing pad 50 in the width direction.

The sensor sheet 1 is attached onto the wearer-side surface of the absorber 55 within the surface of the absorber 55 so as to extend from one end portion (end portion of the stomach-side portion 51) to the other end portion (end portion of the back-side portion 52) of the absorber 55 in the longitudinal direction.

In the example of FIG. 1, as indicated by a dashed line, a sensor device 10 of the sensor sheet 1 is placed at the stomach-side portion 51 of the urine absorbing pad 50. In the example of FIG. 1, the sensor device 10 is provided at a stomach-side position corresponding to the bladder of the wearer when the absorbable product is worn.

The urine absorbing pad 50 is worn with the sensor sheet 1 attached as described above, and therefore, when the wearer excretes urine, the urine penetrates the sensor sheet 1 and is absorbed by the absorber 55 of the urine absorbing pad 50, and is guided to the sensor device 10 by the sensor sheet 1. As a result, the wetness of the urine absorbing pad 50 can be detected by a detection apparatus (not shown) that wirelessly communicates with the sensor device 10. That is, the sensor sheet 1 can be used as a urination sensor capable of detecting the wetness of the absorbable product such as the urine absorbing pad 50 and notifying a carer of absorbable product replacement timing.

Note that the urine absorbing pad 50 to which the sensor sheet 1 is attached is not limited to the configuration of the example of FIG. 1. The sensor sheet 1 can be used in combination with urine absorbing pads of various configurations having absorbers 55. The absorbable product provided with the sensor sheet 1 is not limited to the urine absorbing pad, and for example, may be a disposable diaper as described above.

In the example of FIG. 1, the sensor device 10 is provided at the stomach-side portion 51 of the sensor sheet 1, but may be provided at the back-side portion 52.

Next, a detailed configuration of the sensor sheet 1 will be described.

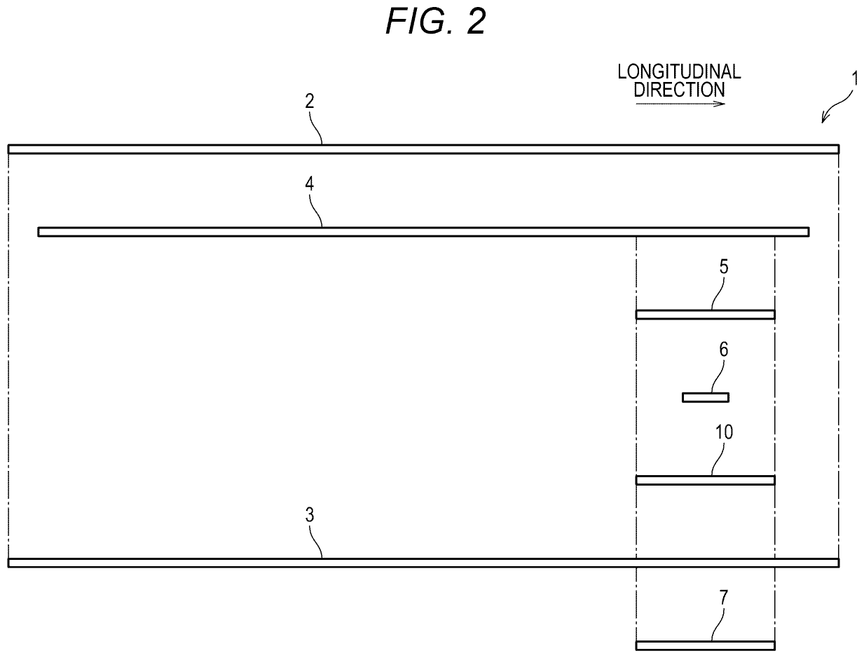

FIG. 2 is a view schematically showing a multilayer structure of the wetness detection sensor sheet 1 (sensor sheet 1) according to the present embodiment.

The sensor sheet 1 is a laminated body formed in a flat plate shape. The sensor sheet 1 is configured such that a wearer-side water-permeable sheet 2, a water-conducting sheet 4, a water-absorbing sheet 5, a water-absorbing expansion material 6, the sheet-shaped sensor device 10, an outer water-permeable sheet 3, and a slip-proof sheet 7 are laminated on each other in this order from the wearer side to the outside. More specifically, in the sensor sheet 1, the water-conducting sheet 4, the water-absorbing sheet 5, the water-absorbing expansion material 6, and the sensor device 10 laminated on each other are sandwiched between the wearer-side water-permeable sheet 2 and the outer water-permeable sheet 3, and the slip-proof sheet 7 is provided on the surface (outer surface) of the outer water-permeable sheet 3 opposite to the water-conducting sheet 4.

The outer shapes of the wearer-side water-permeable sheet 2 and the outer water-permeable sheet 3 are the same as each other, are coincident with each other in plan view, and form the outer shape of the sensor sheet 1.

An adhesive or a pressure-sensitive adhesive (not shown) is applied to at least one of the surface (lower surface of the wearer-side water-permeable sheet 2 in FIG. 2) of the wearer-side water-permeable sheet 2 opposite to the wearer side or the wearer-side surface (upper surface of the outer water-permeable sheet 3 in FIG. 2) of the outer water-permeable sheet 3, and peripheral edge portions of the wearer-side water-permeable sheet 2 and the outer water-permeable sheet 3 are joined to each other by pressure bonding. The wearer-side water-permeable sheet 2 and the outer water-permeable sheet 3 may be joined to each other by thermal fusion bonding. In this manner, the peripheries of the water-conducting sheet 4, the water-absorbing sheet 5, the water-absorbing expansion material 6, and the sensor device 10 laminated between the wearer-side water-permeable sheet 2 and the outer water-permeable sheet 3 are held by the wearer-side water-permeable sheet 2 and the outer water-permeable sheet 3. That is, the water-conducting sheet 4, the water-absorbing sheet 5, the water-absorbing expansion material 6, the sensor device 10, and the slip-proof sheet 7 have such shapes and sizes that these components are located within the surfaces of the wearer-side water-permeable sheet 2 and the outer water-permeable sheet 3 in plan view.

The wearer-side water-permeable sheet 2 and the outer water-permeable sheet 3 are only required to be sheets having favorable water permeability, and the materials and manufacturing methods thereof are not limited. Note that the materials of the wearer-side water-permeable sheet 2 and the outer water-permeable sheet 3 are preferably chemical fiber-based materials holding no moisture, such as polyethylene, polypropylene, or polyethylene terephthalate. Preferably, the wearer-side water-permeable sheet 2 and the outer water-permeable sheet 3 are formed of, for example, 100% chemical fiber non-woven fabric having low water retentivity, such as spunbond non-woven fabric, thermalbond non-woven fabric, or airthrough non-woven fabric, and are subjected to hydrophillic treatment for improving the water permeability.

The outer water-permeable sheet 3 preferably has higher toughness than that of the wearer-side water-permeable sheet 2. The toughness of the wearer-side water-permeable sheet 2 is not necessarily so high in order to maintain good texture because the wearer-side water-permeable sheet 2 is supported by, e.g., other pieces of non-woven fabric.

In the present embodiment, the water-conducting sheet 4 is placed on one side (wearer side) of the sensor device 10 in an overlapping manner between the wearer-side water-permeable sheet 2 and the outer water-permeable sheet 3. The water-conducting sheet 4 may be provided on each side of the sensor device 10 in an overlapping manner. In other words, the water-conducting sheet 4 may be placed on one or both sides of the sensor device 10 in an overlapping manner. The water-conducting sheet 4 is placed only on one side (upper side) as in the present embodiment, so that a manufacturing cost can be reduced.

The planar shape of the water-conducting sheet 4 is a substantially rectangular shape, and the water-conducting sheet 4 has such a size that the water-conducting sheet 4 is located within the surfaces of the wearer-side water-permeable sheet 2 and the outer water-permeable sheet 3 in plan view. That is, in plan view, the water-conducting sheet 4 is provided within the wearer-side water-permeable sheet 2 and the outer water-permeable sheet 3. Specifically, the planar size of the water-conducting sheet 4 is smaller than those of the wearer-side water-permeable sheet 2 and the outer water-permeable sheet 3 by the size of the peripheral edge portions of the wearer-side water-permeable sheet 2 and the outer water-permeable sheet 3 connected to each other.

Thus, the water-conducting sheet 4 extends from the stomach-side portion 51 to the back-side portion 52 through the coupling portion 53 of the urine absorbing pad 50 in a state of the sensor sheet 1 being attached to the urine absorbing pad 50. That is, as described above, the water-conducting sheet 4 is provided so as to extend from the stomach side to the back side through below the crotch of the wearer when the absorbable product is worn. Preferably, the water-conducting sheet 4 is provided so as to extend from a specific stomach-side portion to a specific back-side portion through below the crotch of the wearer when the absorbable product is worn.

In other words, the water-conducting sheet 4 extends along the longitudinal direction of the sensor sheet 1, and one end side, the center, and the other end side of the water-conducting sheet 4 in the longitudinal direction respectively correspond to the stomach side, below the crotch, and the back side of the wearer when the wearer wears the absorbable product.

The water-conducting sheet 4 is only required to be formed so that part of liquid having penetrated the wearer-side water-permeable sheet 2 can be guided forward (toward the stomach side) to the sensor device 10, and, e.g., the manufacturing method and material thereof are not limited. The water-conducting sheet 4 is formed of, for example, high water-retaining non-woven fabric such as cotton, pulp, rayon, or cupra.

The water-conducting sheet 4 is preferably manufactured using a manufacturing method such as a spunlace method or a needle punch method such that a fiber orientation is in a water conducting direction (forward to the sensor device 10). With this configuration, liquid excreted to an under-crotch region of the sensor sheet 1 can be reliably guided to the sensor device 10 at a position apart from the under-crotch region.

The sensor device 10 is formed in a sheet shape, and has a substantially rectangular planar shape short in the longitudinal direction and long in the width direction of the sensor sheet 1.

The sensor device 10 is provided on the side closer to a region of the water-conducting sheet 4 corresponding to the stomach side of the wearer with respect to a region of the water-conducting sheet 4 corresponding to below the crotch of the wearer.

Specifically, the sensor device 10 is placed on the wearer-side surface of the outer water-permeable sheet 3 through an adhesive or a pressure-sensitive adhesive at a position closer to a front end portion (stomach-side end portion) of the outer water-permeable sheet 3 in the longitudinal direction. In other words, the sensor device 10 is provided in a region closer to the stomach-side end portion with respect to the under-crotch region corresponding to below the crotch of the wearer in the longitudinal direction of the water-conducting sheet 4 in plan view.

The sensor device 10 may be provided on the side closer to a region of the water-conducting sheet 4 corresponding to the back side of the wearer (specifically, region closer to a back-side end portion) with respect to the region of the water-conducting sheet 4 corresponding to below the crotch of the wearer.

In other words, the sensor device 10 may be provided in a region closer to one end side (stomach side) or the other end side (back side) of the water-conducting sheet 4 in the longitudinal direction with respect to the center of the water-conducting sheet 4 in the longitudinal direction, which corresponds to below the crotch of the wearer. The sensor device 10 is provided at the position apart from the region corresponding to below the crotch of the wearer, so that a wearer's feeling of strangeness due to the sensor device 10 can be reduced and a feeling of discomfort when the sensor sheet 1 is worn can be reduced.

Note that a detailed structure of the sensor device 10 itself will be described later.

The water-absorbing expansion material 6 is provided on a specific region of the wearer-side surface (region including at least a region provided with later-described missing portions 14a, 14b) of the sensor device 10. The water-absorbing expansion material 6 is configured to expand by water absorption to press the specific region of the sensor device 10 in the direction perpendicular to the plane thereof. The features of the water-absorbing expansion material 6 will be described later.

The water-absorbing expansion material 6 is only required to be formed to expand by water absorption, and the manufacturing method and material thereof are not limited. For example, the water-absorbing expansion material 6 is made of compressed cellulose sponge or water-absorbing polymer.

The water-absorbing sheet 5 is provided between the water-absorbing expansion material 6 and the water-conducting sheet 4.

The water-absorbing sheet 5 has a shape and a size substantially similar to those of the sensor device 10, and in plan view, is placed so as to overlap with the sensor device 10.

The water-absorbing sheet 5 absorbs and retains liquid guided by the water-conducting sheet 4. The liquid having seeped from the water-absorbing sheet 5 reaches the water-absorbing expansion material 6 and the sensor device 10.

The water-absorbing sheet 5 is only required to be formed to be able to absorb and retain a certain amount of liquid, and the manufacturing method and material thereof are not limited. For example, the water-absorbing sheet 5 is formed of high-absorbent resin-containing (SAP-containing) fiber non-woven fabric or SAP-mixed non-woven fiber.

With this multilayer structure of the sensor sheet 1, most of liquid excreted from the wearer onto the under-crotch region of the wearer-side water-permeable sheet 2 sequentially penetrates the wearer-side water-permeable sheet 2, the water-conducting sheet 4, and the outer water-permeable sheet 3, and is absorbed by the absorber 55 of the urine absorbing pad 50. Meanwhile, part of the liquid is guided forward (toward the stomach side) by the water-conducting sheet 4 and is absorbed and retained by the water-absorbing sheet 5, and the liquid having seeped from the water-absorbing sheet 5 expands the water-absorbing expansion material 6 and reaches the sensor device 10.

Thus, according to the sensor sheet 1, the liquid excreted from the wearer can be reliably guided to the sensor device 10 at the position apart from the under-crotch region.

The slip-proof sheet 7 is provided on the surface (outer surface) of the outer water-permeable sheet 3 opposite to the wearer side. The slip-proof sheet 7 suppresses misalignment of the sensor sheet 1 relative to the urine absorbing pad 50. The slip-proof sheet 7 suppressing the misalignment of the sensor sheet 1 indicates that the sensor sheet 1 is indirectly overlapped on the absorbable product through the slip-proof sheet 7, so that the sensor sheet 1 is less likely to move along the surface of the absorbable product, as compared to a case where the sensor sheet 1 is directly overlapped on the absorbable product. Thus, one surface (wearer-side surface) of the slip-proof sheet 7 of the present embodiment is joined to the outer surface of the outer water-permeable sheet 3 with an adhesive or a pressure-sensitive adhesive, and the other surface (outer surface) has a pressure-sensitive adhesive layer or an adhesive layer (not shown) and is fixed to the urine absorbing pad 50 through the pressure-sensitive adhesive layer or the adhesive layer. Note that in a case, e.g., where the sensor sheet 1 is formed separately from the urine absorbing pad 50, a release sheet releasable from the pressure-sensitive adhesive layer or the adhesive layer is provided on the outer surface of the slip-proof sheet 7. In this case, in order to ensure easy releasability, a release layer on which resin such as polyethylene or silicon is laminated may be provided between the release sheet and the pressure-sensitive adhesive layer or the adhesive layer. Instead of the present embodiment, many fine protrusions may be formed on the surface of the slip-proof sheet 7, and may engage with the surfaces of the sensor sheet 1 and the absorbable product. In this manner, the misalignment of the sensor sheet 1 may be suppressed.

Note that the wearer-side water-permeable sheet 2 and the outer water-permeable sheet 3 may be referred to as a first water-permeable sheet and a second water-permeable sheet, respectively.

In the present embodiment, the slip-proof sheet 7 has a shape and a size substantially similar to those of the sensor device 10, and is placed so as to at least partially overlap with the sensor device 10 in plan view. More specifically, the slip-proof sheet 7 is placed such that the center thereof is coincident with that of the sensor device 10 in plan view, and the entirety of the slip-proof sheet 7 overlaps with the sensor device 10. As described above, the slip-proof sheet 7 is preferably provided within the surface of the sensor device 10 in plan view. That is, the slip-proof sheet 7 is preferably included in the sensor device 10 in plan view.

Here, it is important for the absorbable product to function to reliably absorb liquid such as urine and prevent the liquid from returning to the wearer side. Thus, the sensor sheet 1 worn together with the absorbable product needs not to interfere with such a function of the absorbable product as much as possible. On the other hand, the sensor device 10 and the slip-proof sheet 7 are present as components of the sensor sheet 1 for blocking penetration of liquid to the urine absorbing pad 50.

Thus, the slip-proof sheet 7 is provided within the surface of the sensor device 10 in plan view, so that the area of the component for blocking the liquid penetration can be minimized and the interference with the above-described important function of the absorbable product can be suppressed to a minimum.

Note that in order to obtain the above-described features and effects, the slip-proof sheet 7 may be formed such that a partial region thereof does not overlap with the sensor device 10 in plan view although the effects are lowered to some extent. In this case, the region of the slip-proof sheet 7 overlapping with the sensor device 10 preferably has a size occupying over the half of the entire region of the slip-proof sheet 7.

### Sensor Device 10

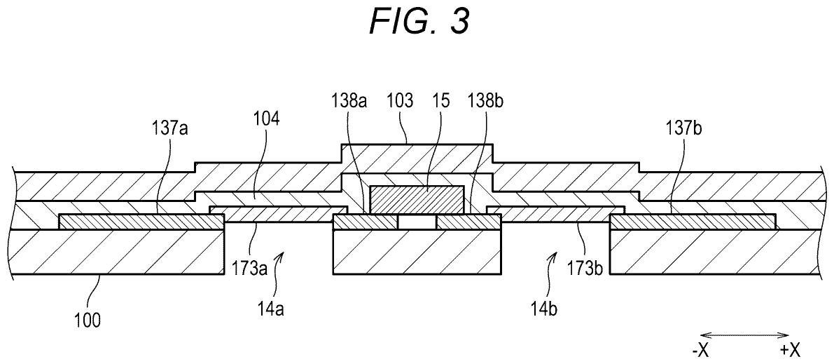

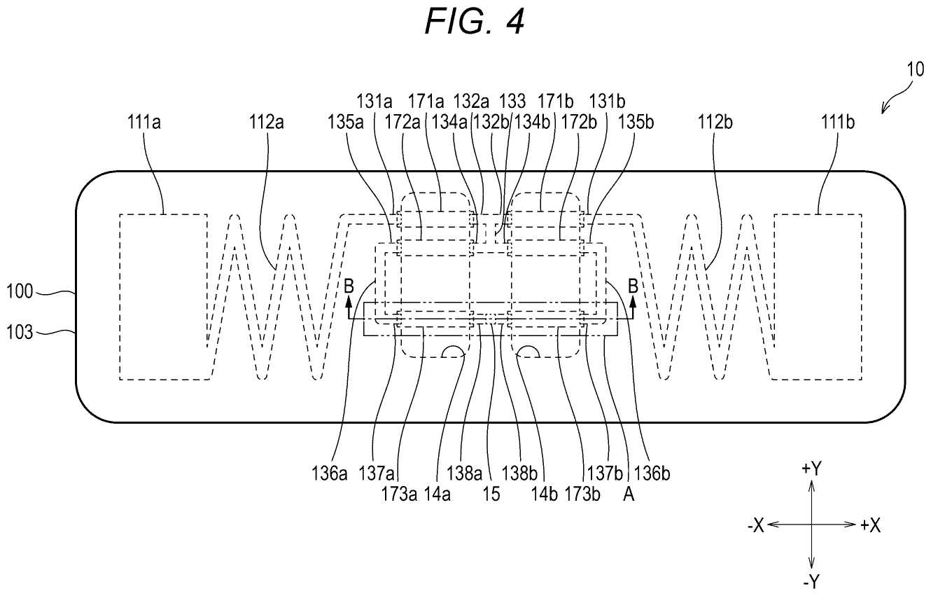

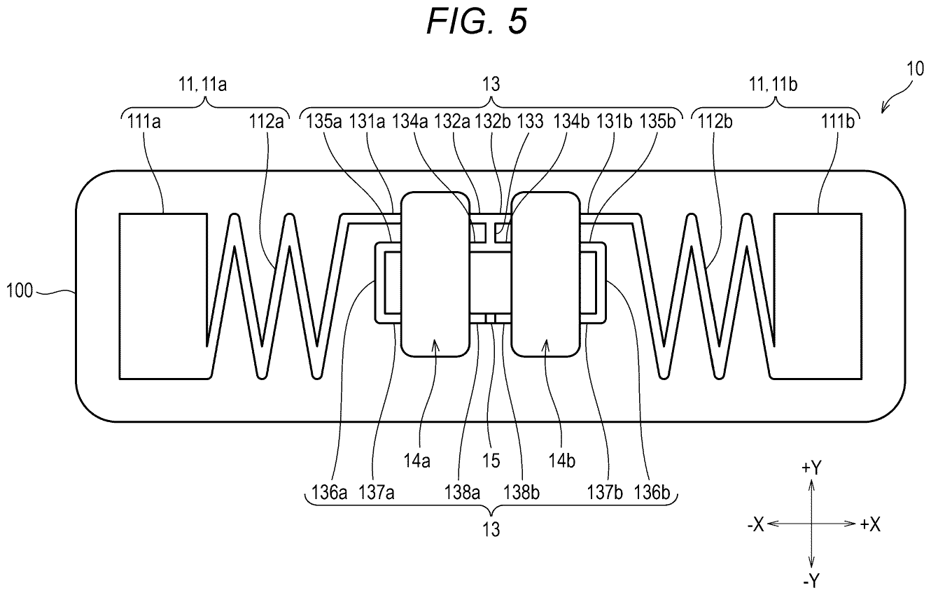

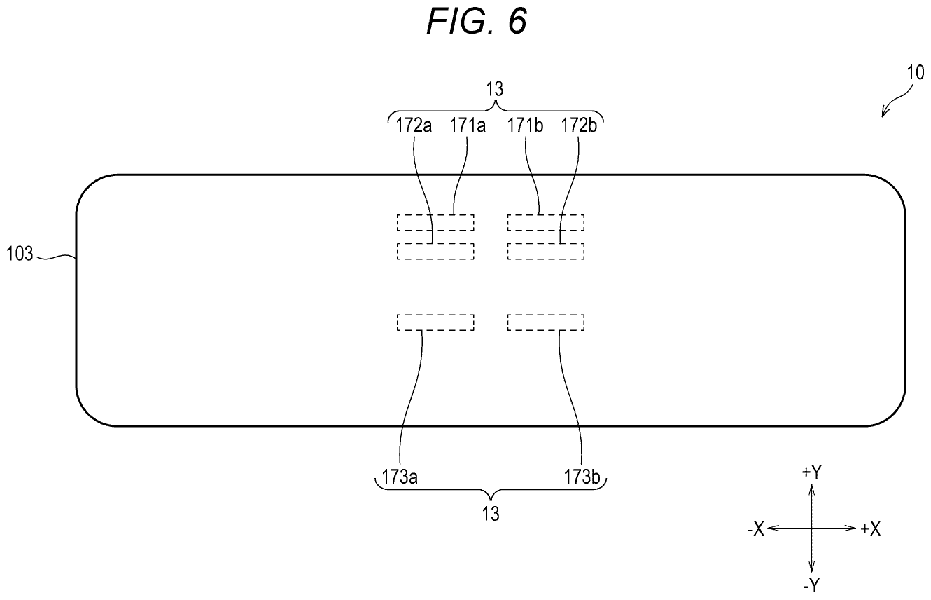

FIG. 3 is a partial end view of the sensor device 10, and FIG. 4 is a plan view of the sensor device 10 when viewed from the wearer side. FIG. 5 selectively shows, when viewed from the wearer side, a base 100 of the sensor device 10 and an antenna portion 11, a conductive wiring portion 13, and a communication portion 15 provided on the wearer-side surface of the base 100. FIG. 6 selectively shows, when viewed from the wearer side, a base 103 of the sensor device 10 and a conductive wiring portion 13 provided on the surface of the base 103 opposite to the wearer side. Note that FIG. 3 shows an end surface of a region A (region surrounded by a frame indicated by a dash-dot-dot line) shown in FIG. 4, which is cut along a B-B line.

The sensor device 10 according to the present embodiment is configured such that the conductive wiring portion 13 is brought into a disconnection state according to a water-absorbing state of the water-absorbing sheet 5 or the water-absorbing expansion material 6. When the conductive wiring portion 13 is brought into the disconnection state, the detection apparatus can no longer normally wirelessly communicate with the sensor device 10, or the characteristics of the wireless communication with the sensor device 10 change. Accordingly, the detection apparatus can detect the wetness of the absorbable product.

In the present embodiment, the detection apparatus can detect the wetness when the conductive wiring portion 13 is broken or damaged, but part of the antenna portion 11 or both the antenna portion 11 and the conductive wiring portion 13 may be brought into the disconnection state.

When the state of the wireless communication between the detection apparatus and the sensor device 10 changes or the wireless communication characteristics change, the detection apparatus can detect the wetness. Thus, the disconnection state of the antenna portion 11 or the conductive wiring portion 13 is not limited to the breakage and the damage, and may be achieved by, e.g., dissolving or weakening.

Hereinafter, an X direction and a Y direction shown in each figure will be used for describing, e.g., a positional relationship among the components of the sensor device 10. The X direction and the Y direction in each figure are directions (horizontal directions) parallel with the direction of the plane of the sensor device 10. Moreover, the Y direction is the longitudinal direction of the sensor sheet 1, and the X direction is the width direction of the sensor sheet 1.

In the X direction, a direction toward +X will be referred to as a +X direction or a +X side, and a direction toward −X will be referred to as a −X direction or a −X side. In the Y direction, a direction toward +Y will be referred to as a +Y direction or a +Y side, and a direction toward −Y will be referred to as a-Y direction or a −Y side.

The thickness direction of the sensor sheet 1 may be referred to as an upper-lower direction. The upper side of the sensor sheet 1 is the wearer side, and the lower side is the urine absorbing pad 50 side.

The sensor device 10 includes the antenna portion 11, the conductive wiring portion 13, and the communication portion 15. As shown in FIGS. 5 and 6, the antenna portion 11, the conductive wiring portion 13, and the communication portion 15 are formed in such a manner that the base 100 and the base 103 are overlapped on each other.

The antenna portion 11 is connected to the communication portion 15 through the conductive wiring portion 13. That is, the conductive wiring portion 13 connects the antenna portion 11 and the communication portion 15 to each other.

The antenna portion 11 includes an antenna portion 11a and an antenna portion 11b. The two antenna portion 11a and antenna portion 11b are symmetrically located on both sides of the sensor device 10 in the X direction with the conductive wiring portion 13 and the communication portion 15 interposed therebetween. The antenna portion 11a is located on the −X side with respect to the conductive wiring portion 13 and the communication portion 15, and the antenna portion 11b is located on the +X side with respect to the conductive wiring portion 13 and the communication portion 15. Hereinafter, unless otherwise required, the antenna portion 11a and the antenna portion 11b will be collectively referred to as an “antenna portion 11”.

The antenna portion 11 wirelessly communicates with the detection apparatus which is external equipment. A radio wave output from the detection apparatus is received by the antenna portion 11, and a signal corresponding to the radio wave is transmitted to the communication portion 15 via the conductive wiring portion 13.

The communication portion 15 receives the signal received by the antenna portion 11 via the conductive wiring portion 13, and transmits a signal to the detection apparatus via the antenna portion 11. In the present embodiment, the communication portion 15 is an IC chip for RFID tags, and is a passive IC chip to be operated with power excited by the detection apparatus via the antenna portion 11.

In the present embodiment, the antenna portion 11 or the conductive wiring portion 13 is configured to be brought into the disconnection state according to the water-absorbing state of the water-absorbing sheet 5 or the water-absorbing expansion material 6. Thus, the signal (radio wave) transmitted from the communication portion 15 to the detection apparatus via the antenna portion 11 as described above can be used as a signal (radio wave) corresponding to the water-absorbing state of the water-absorbing sheet 5 or the water-absorbing expansion material 6, i.e., the degree of wetness of the absorbable product. That is, the sensor device 10 of the present disclosure is configured to be capable of outputting (transmitting) the radio wave corresponding to the degree of wetness of the absorbable product to the outside via the wireless communication.

The antenna portion 11 has wide portion 111a, 111b and zigzag portion 112a, 112b. The wide portion 111a, 111b is formed in a substantially rectangular shape long in the Y direction in plan view. The zigzag portions 112a, 112b is formed narrower than the wide portion 111a, 111b, and extends in the X direction while extending zigzag in the Y direction. One ends of the zigzag portions 112a, 112b are respectively connected to the wide portions 111a, 111b, and the other ends are respectively connected to the conductive wiring portion 13.

The conductive wiring portion 13 is wiring connecting the antenna portion 11 and the communication portion 15 to each other, and is formed such that wiring provided on the surface of the base 100 facing the base 103 and wiring provided on the surface of the base 103 facing the base 100 are connected to each other.

First, the configuration of the conductive wiring portion 13 provided on the base 100 will be described with reference to FIG. 5.

The conductive wiring portion 13 has a linear pattern forming portion 131a, a linear pattern forming portion 132a, a linear pattern forming portion 132b, and a linear pattern forming portion 131b. The linear pattern forming portion 131a is connected to one end of the zigzag portion 112a, and extends in the X direction. The linear pattern forming portion 132a is located on the extension of the linear pattern forming portion 131a with the missing portion 14a interposed therebetween, and extends in the X direction. The linear pattern forming portion 132b is continuously connected to the linear pattern forming portion 132a, and extends in the X direction. The linear pattern forming portion 131b is located on the extension of the linear pattern forming portion 132b with the missing portion 14b interposed therebetween, and extends in the X direction.

Further, the conductive wiring portion 13 has a coupling portion 133 and annular pattern forming portions 134a, 135a, 136a, 137a, 138a, 134b, 135b, 136b, 137b, 138b. One end of the coupling portion 133 is connected to a boundary portion between the linear pattern forming portion 132a and the linear pattern forming portion 132b, and the coupling portion 133 extends from the boundary portion in the Y direction.

The annular pattern forming portion 134a is connected to the other end of the coupling portion 133, and extends from the other end of the coupling portion 133 in the X direction. The annular pattern forming portion 135a is located on the extension of the annular pattern forming portion 134a with the missing portion 14a interposed therebetween, and extends in the X direction. One end of the annular pattern forming portion 136a is connected to one end of the annular pattern forming portion 135a, and the annular pattern forming portion 136a extends from the other end of the annular pattern forming portion 135a in the Y direction. The annular pattern forming portion 137a is connected to the other end of the annular pattern forming portion 136a, and extends from the other end of the annular pattern forming portion 136a in the X direction. The annular pattern forming portion 138a is located on the extension of the annular pattern forming portion 137a with the missing portion 14a interposed therebetween, and extends in the X direction.

The annular pattern forming portion 134b is connected to the other end of the coupling portion 133, and extends from the other end of the coupling portion 133 in the X direction. The annular pattern forming portion 135b is located on the extension of the annular pattern forming portion 134b with the missing portion 14b interposed therebetween, and extends in the X direction. One end of the annular pattern forming portion 136b is connected to one end of the annular pattern forming portion 135b, and the annular pattern forming portion 136b extends from the one end of the annular pattern forming portion 135b in the Y direction. The annular pattern forming portion 137b is connected to the other end of the annular pattern forming portion 136b, and extends from the other end of the annular pattern forming portion 136b in the X direction. The annular pattern forming portion 138b is located on the extension of the annular pattern forming portion 137b with the missing portion 14b interposed therebetween, and extends in the X direction.

The annular pattern forming portion 138a and the annular pattern forming portion 138b are connected to the communication portion 15. The annular pattern forming portion 138a is located on the extension of the annular pattern forming portion 138b via the communication portion 15, and vice versa.

Next, the configuration of the conductive wiring portion 13 provided on the base 103 will be described with reference to FIGS. 4 and 6.

As shown in FIG. 6, the conductive wiring portion 13 has bridge portions 171a, 171b, 172a, 172b, 173a, 173b provided on the base 103 and extending in the X direction.

The base 100 and the base 103 are overlapped on each other, and in this manner, the wiring of the conductive wiring portion 13 is formed as shown in FIG. 4.

Specifically, the bridge portion 171a connects the linear pattern forming portion 131a and the linear pattern forming portion 132a to each other. The bridge portion 171b connects the linear pattern forming portion 132b and the linear pattern forming portion 131b to each other. With this configuration, the linear pattern forming portion 131a, the bridge portion 171a, the linear pattern forming portion 132a, the linear pattern forming portion 132b, the bridge portion 171b, and the linear pattern forming portion 131b form a linear wiring pattern of the conductive wiring portion 13 linearly extending in the X direction.

The bridge portion 172a connects the annular pattern forming portion 135a and the annular pattern forming portion 134a to each other. The bridge portion 172b connects the annular pattern forming portion 134b and the annular pattern forming portion 135b to each other. The bridge portion 173a connects the annular pattern forming portion 137a and the annular pattern forming portion 138a to each other. The bridge portion 173b connects the annular pattern forming portion 138b and the annular pattern forming portion 137b to each other. With this configuration, the annular pattern forming portion 138a, the bridge portion 173a, the annular pattern forming portion 137a, the annular pattern forming portion 136a, the annular pattern forming portion 135a, the bridge portion 172a, the annular pattern forming portion 134a, the annular pattern forming portion 134b, the bridge portion 172b, the annular pattern forming portion 135b, the annular pattern forming portion 136b, the annular pattern forming portion 137b, the bridge portion 173b, and the annular pattern forming portion 138b form an annular wiring pattern of the conductive wiring portion 13. The annular wiring pattern is formed in a substantially rectangular annular shape in plan view. Note that the communication portion 15 is connected between the annular pattern forming portion 138a and the annular pattern forming portion 138b, and therefore, the annular wiring pattern is non-continuous at the position of the communication portion 15. The coupling portion 133 couples the linear wiring pattern and annular wiring pattern of the conductive wiring portion 13 to each other.

Each of the bridge portion 171a, the bridge portion 172a, and the bridge portion 173a is located over the missing portion 14a, and each of the bridge portion 171b, the bridge portion 172b, and the bridge portion 173b is located over the missing portion 14b.

The bridge portion 173a is bridged between the annular pattern forming portion 137a and the annular pattern forming portion 138a, and electrically connects the annular pattern forming portion 137a and the annular pattern forming portion 138a to each other. Similarly, the bridge portion 173b is bridged between the annular pattern forming portion 138b and the annular pattern forming portion 137b, and electrically connects the annular pattern forming portion 138b and the annular pattern forming portion 137b to each other.

Similarly, the bridge portion 171a is bridged between the linear pattern forming portion 131a and the linear pattern forming portion 132a, and electrically connects the linear pattern forming portion 131a and the linear pattern forming portion 132a to each other. The bridge portion 171b is bridged between the linear pattern forming portion 132b and the linear pattern forming portion 131b, and electrically connects the linear pattern forming portion 132b and the linear pattern forming portion 131b to each other. The bridge portion 172a is bridged between the annular pattern forming portion 135a and the annular pattern forming portion 134a, and electrically connects the annular pattern forming portion 135a and the annular pattern forming portion 134a to each other. The bridge portion 172b is bridged between the annular pattern forming portion 134b and the annular pattern forming portion 135b, and electrically connects the annular pattern forming portion 134b and the annular pattern forming portion 135b to each other.

As described above, the sensor device 10 in the present embodiment is formed in such a manner that the base 100 and the base 103 are overlapped on each other.

The base 100 is formed to be insoluble in liquid. The base 100 may be made of, for example, paper or a resin film. Examples of a resin material forming the resin film may include, but not specifically limited to, polyethylene, polystyrene, polypropylene, and polyester.

Note that the base 100 may be formed to be soluble in liquid. The thickness dimension of the base 100 is, but not specifically limited to, preferably 10 μm or more and 75 μm or less, for example. Since the thickness dimension of the base 100 is 10 μm or more, the base 100 can stably support, e.g., the wiring pattern of the antenna portion 11, and the structural strength thereof can be sufficiently obtained. Since the thickness dimension of the base 100 is 75 μm or less, favorable flexibility of the base 100 is obtained.

The base 103 is formed to be soluble in liquid. Thus, when slight external force is applied to the wiring pattern of the conductive wiring portion 13 provided on the base 103 in a state of the base 103 being dissolved due to sufficient contact with liquid, the wiring pattern can be easily broken or cracked, and therefore, the sensor device 10 can be brought into the disconnection state. Accordingly, a state of the sensor device 10 being soaked in the liquid can be more reliably detected.

Here, the base 103 being soluble in liquid indicates that the base 103 is dissolved (melted) due to contact with liquid. More specifically, for example, liquid contains water, and the base 103 being soluble in liquid indicates that the base 103 is dissolved due to contact with water (liquid).

The base 103 contains polyvinyl alcohol (PVA), for example. Since the base 103 contains PVA, a structure of the base 103 being favorably dissolved when contacting liquid can be implemented. Note that when the base 103 is water-soluble, the material of the base 103 is not limited to PVA and may be, for example, a polyvinylpyrrolidone, water-soluble polyester, or water-soluble paper material or a sheet material derived from a starch component.

The thickness dimension of the base 103 is, but not specifically limited to, preferably 5 μm or more and 100 μm or less, for example. Since the thickness dimension of the base 103 is 5 μm or more, the base 103 can stably support the wiring pattern of the conductive wiring portion 13 at a stage before contact with liquid. Since the thickness dimension of the base 103 is 100 μm or less, the base 103 can be quickly dissolved when contacting liquid.

Next, a multilayer structure of part (region A shown in FIG. 4) of the sensor device 10 will be specifically described with reference to FIG. 3.

In a region A of the sensor device 10, the annular pattern forming portions 137a, 138a, 137b, 138b are formed on the wearer-side surface (upper surface) of the base 100. The communication portion 15 is provided in electric connection with the annular pattern forming portion 138a and the annular pattern forming portion 138b between the annular pattern forming portion 138a and the annular pattern forming portion 138b. The form of connection between the communication portion 15 and the annular pattern forming portions 138a, 138b is not limited, but for example, one mount terminal of the communication portion 15 is electrically connected to one end of the annular pattern forming portion 138a, and the other mount terminal of the communication portion 15 is electrically connected to one end of the annular pattern forming portion 138b.

In the region A of the sensor device 10, the missing portions 14a, 14b are provided in the base 100.

The missing portions 14a, 14b are openings formed in the base 100. That is, the missing portions 14a, 14b penetrate the base 100 from the front to the back thereof in the thickness direction (upper-lower direction) of the base 100. Thus, in the region of the base 100 where the missing portions 14a, 14b are present, no wiring pattern of the conductive wiring portion 13 is formed. Note that the missing portions 14a, 14b may be in a slit shape.

In the region A of the sensor device 10, the bridge portions 173a, 173b are formed in the surface of the base 103 facing the base 100. More specifically, the bridge portions 173a, 173b are formed in regions overlapping with the missing portions 14a, 14b in such a surface of the base 103. The bridge portion 173a is bridged between the annular pattern forming portion 137a and the annular pattern forming portion 138a, and electrically connects the annular pattern forming portion 137a and the annular pattern forming portion 138a to each other. The bridge portion 173b is bridged between the annular pattern forming portion 138b and the annular pattern forming portion 137b, and electrically connects the annular pattern forming portion 138b and the annular pattern forming portion 137b to each other.

Note that in the present embodiment, the bridge portions 173a, 173b are formed in the surface of the base 103 facing the base 100 through a soluble layer 104 which is a pressure-sensitive adhesive layer soluble in liquid. Examples of a pressure-sensitive adhesive forming such a water-soluble (or aqueous) soluble layer 104 include, but not specifically limited to, a starch glue, an acacia glue, and an aqueous acrylic emulsion. For example, the aqueous acrylic emulsion is produced in such a manner that acrylic monomer containing a carboxyl group is copolymerized and alcohol or polyethylene oxide is added thereto. The soluble layer 104 may contain two or more types of water-soluble (or aqueous) pressure-sensitive adhesives.

The soluble layer 104 not only makes the base 103 and the bridge portions 173a, 173b adhere to each other, but also makes the base 103 and the base 100 adhere to each other and makes the base 103 and the annular pattern forming portions 137a, 138a, 137b, 138b adhere to each other.

Note that the multilayer structure of part (region A shown in FIG. 4) of the sensor device 10 in the present embodiment is not limited to that of the example shown in FIG. 3. For example, a pressure-sensitive adhesive layer and a soluble layer may be provided on the regions of the bridge portions 173a, 173b overlapping with the missing portions 14a, 14b. In this case, the missing portions 14a, 14b are covered with the pressure-sensitive adhesive layer, the soluble layer is laminated on the pressure-sensitive adhesive layer, and then, the bridge portions 173a, 173b are laminated thereon. In a region provided with no pressure-sensitive adhesive layer and soluble layer, the bridge portion 173a electrically connects the annular pattern forming portion 137a and the annular pattern forming portion 138a to each other, and the bridge portion 173b electrically connects the annular pattern forming portion 138b and the annular pattern forming portion 137b to each other.

With this structure, the conductive wiring portion 13 of the sensor device 10 is brought into the disconnection state when the sensor device 10 contacts liquid guided by the water-conducting sheet 4 and absorbed by and seeped from the water-absorbing sheet 5. Specifically, the base 103 is dissolved when sufficiently contacting the liquid having seeped from the water-absorbing sheet 5, and the water-absorbing expansion material 6 having absorbed the liquid expands, so that pressing force is applied to the missing portions 14a, 14b in the direction perpendicular to the plane of the base 103. With this pressing force, any one or more of the bridge portions 171a, 172a, 173a, 171b, 172b, 173b are broken or cracked, thereby the conductive wiring portion 13 is brought into the disconnection state.

The wiring patterns of the antenna portion 11 and the conductive wiring portion 13 in the present embodiment are configured to be insoluble in liquid. Note that the formation methods and materials of the wiring patterns of the antenna portion 11 and the conductive wiring portion 13 are not limited to this example. The wiring patterns of the antenna portion 11 and the conductive wiring portion 13 may be formed to be soluble in liquid, or may be formed to become brittle when getting wet with liquid.

A structure of bringing the antenna portion 11 or the conductive wiring portion 13 into the disconnection state is not limited only to that of the present embodiment.

As described above, the sensor sheet 1 in the present embodiment includes the water-absorbing sheet 5 and the water-absorbing expansion material 6 as water-absorbing members, and timing of bringing the sensor device 10 into the disconnection state can be adjusted by the water-absorbing capacities of these members. For example, in a case where the water-absorbing sheet 5 and the water-absorbing expansion material 6 with great water-absorbing capacities are used, the amount of liquid which can bring the sensor device 10 into the disconnection state is greater as compared to a case where the water-absorbing sheet 5 and the water-absorbing expansion material 6 with small water-absorbing capacities are used. That is, when the water-absorbing sheet 5 and the water-absorbing expansion material 6 with great water-absorbing capacities are used, timing of the detection apparatus detecting the wetness can be delayed until the degree of wetness of the absorbable product increases.

For example, multiple types of sensor sheets 1 are provided so as to be provided with water-absorbing members (water-absorbing sheets 5 and water-absorbing expansion materials 6) different from each other in the amount of water absorption which can bring the sensor device 10 into the disconnection state, so that a proper sensor sheet 1 can be selected according to, e.g., the preference of a user such as a carer or an excretion state of the wearer.

These multiple types of sensor sheets 1 can be called a wetness detection sensor sheet set. The wetness detection sensor sheet set may be for a combined sale, or all or some of the multiple types of sensor sheets 1 may be selectively put up for sale.

### Wetness Detection System

Next, a wetness detection system that detects the wetness of the absorbable product having the sensor sheet 1 will be described.

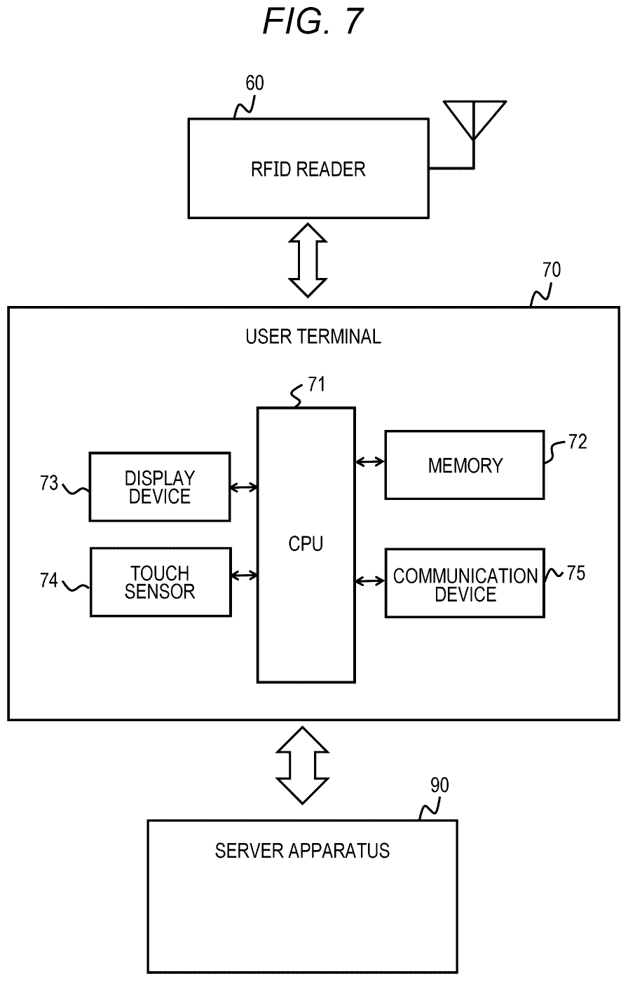

FIG. 7 is a conceptual diagram showing a hardware configuration of the wetness detection system (hereinafter, may be referred to as a system).

The wetness detection system of the present embodiment includes, e.g., an RFID reader 60, a user terminal 70, and a server apparatus 90.

The user terminal 70 is a terminal (computer) to be mainly used by a carer, and for example, has a central processing unit (CPU) 71, a memory 72, a display device 73, a touch sensor 74, and a communication device 75 connected to each other via a bus, as shown in FIG. 7. The user terminal 70 is only required to be a general-purpose computer, and each hardware element forming the user terminal 70 is not limited. The user terminal 70 may include other hardware elements not shown in FIG. 7, such as an imaging unit, a microphone unit, and a speaker unit.

For the sake of easy portability, the user terminal 70 is preferably a mobile terminal such as a smartphone or a tablet.

The CPU 71 controls operation of the entirety of the present system including the hardware elements and software elements. The CPU 71 is connected to other units via a communication line such as a bus. The CPU 71 may include, in addition to a general CPU, an application specific integrated circuit (ASIC), a digital signal processor (DSP), and a graphics processing unit (GPU), for example.

The memory 72 is, e.g., a random access memory (RAM), a read only memory (ROM), or an auxiliary storage apparatus (e.g., hard disk).

The display device 73 includes a monitor such as a liquid crystal display (LCD) or a cathode ray tube (CRT) display, and performs display processing.

The touch sensor 74 senses touch from the outside to receive operation input from the user. The touch sensor 74 may be a sensor capable of detecting a state of the user's fingers and the like approaching from the outside even in a non-contact state. The display device 73 and the touch sensor 74 may be implemented as a touch panel unit. Further, the user terminal 70 may have, in addition to or instead of the touch sensor 74, an input-output interface (not shown) connected to an input apparatus such as a mouse or a keyboard.

The communication device 75 wirelessly communicates with other terminals such as the RFID reader 60 and the server apparatus 90 via a communication network. The communication network is, e.g., a mobile phone network, a wireless fidelity (Wi-Fi) network, an Internet communication network, a leased line network, or a local area network (LAN). In the present embodiment, the communication form of the communication device 75 is not limited.

The user terminal 70 is configured to be capable of wireless communication with the RFID reader 60 and the server apparatus 90 via the communication device 75.

The server apparatus 90 is a so-called computer, and for example, has a CPU, a memory, and an input-output interface (I/F) connected to each other via a bus. These hardware elements forming the server apparatus 90 are similar to those of the user terminal 70, and a hardware configuration of the server apparatus 90 is not limited in any way.

The RFID reader 60 is an apparatus configured to be capable of wireless communication with the sensor device 10 of the sensor sheet 1. The RFID reader 60 has an antenna. The RFID reader 60 outputs, via the antenna, a radio wave (hereinafter, may be referred to as an RFID tag radio wave) having a predetermined frequency band (e.g., UHF band or microwave band) used for the RFID tag, receives a radio wave output from the sensor device 10 of the sensor sheet 1 according to the radio wave, and demodulates and decodes the received radio wave, for example. Note that in the sensor device 10 of the present embodiment, the radio wave with the UHF band is used.

The user terminal 70 can acquire, via the wireless communication with the RFID reader 60, a sensor ID stored in the communication portion 15 of the sensor device 10, which is acquired by, e.g., the demodulation. Note that the form of connection and communication between the RFID reader 60 and the user terminal 70 is not limited in any way.

A hardware configuration of the RFID reader 60 is not shown in the figure, but the RFID reader 60 is only required to have a hardware configuration similar to that of an existing RFID reader.

As described above, the communication portion 15 of the sensor sheet 1 is, in the present embodiment, an IC chip for passive RFID tags. The sensor ID stored in the communication portion 15 of the sensor sheet 1 is an ID unique to each sensor sheet 1. Note that the sensor ID stored in the communication portion 15 is only required to be an identifier unique to each IC chip for RFID tags.

In the description below, the sensor ID may be referred to as one stored in the sensor sheet 1 or the sensor device 10.

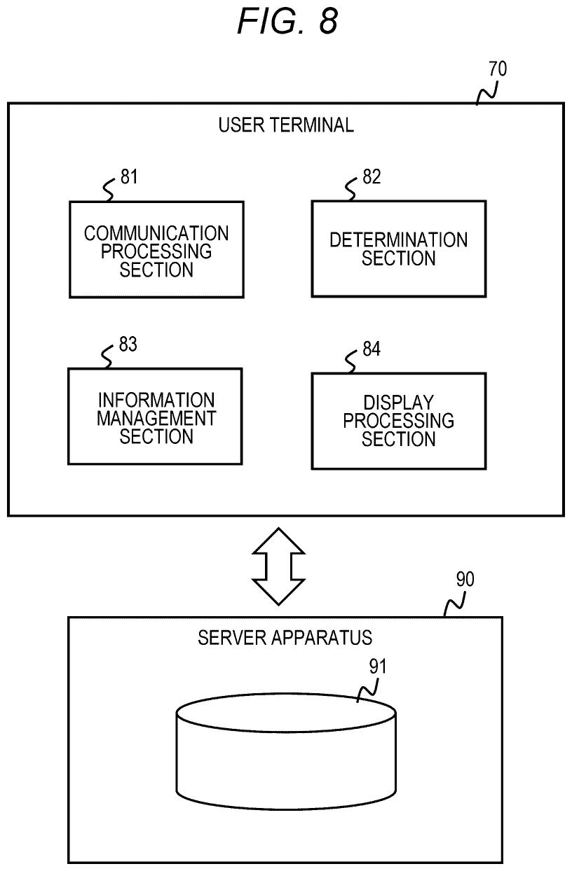

FIG. 8 is a conceptual diagram showing a software configuration of the wetness detection system.

FIG. 8 does not show a software configuration of the RFID reader 60, but the RFID reader 60 is only required to have a general software configuration of an RFID tag reader apparatus. That is, the RFID reader 60 outputs an RFID tag radio wave, receives a radio wave output from the sensor device 10 of the sensor sheet 1 according to the output radio wave, and demodulates and decodes the received radio wave, for example. In this manner, the RFID reader 60 acquires the sensor ID stored in the communication portion 15 of the sensor sheet 1. The RFID reader 60 may output the radio wave according to an instruction signal from the user terminal 70, according to user operation on, e.g., an operation button of the RFID reader 60, or may periodically output the radio wave with no trigger.

When a sensor ID has been successfully acquired, the RFID reader 60 transmits the sensor ID to the user terminal 70. On the other hand, when the sensor ID cannot be acquired even after the radio wave has been repeatedly output a predetermined number of times, the RFID reader 60 transmits information (hereinafter, referred to as no-response information) indicating the absence of response. Note that the RFID reader 60 may be configured to transmit nothing when the sensor ID cannot be acquired. Regardless of whether or not the sensor ID has been successfully acquired, the RFID reader 60 may be configured to determine that there is no response when the intensity of the radio wave output from the sensor device 10 and received by the RFID reader 60 is lower than a predetermined threshold, and generate the no-response information. That is, the RFID reader 60 may be configured to determine that there is no response and generate the no-response information when no predetermined response to the output from the RFID reader 60 is made from the sensor device 10 (e.g., case where the sensor ID cannot be acquired or case where the intensity of the received radio wave is lower than the predetermined threshold).

The server apparatus 90 has at least a wearer management database 91 (hereinafter, may be referred to as a wearer management DB 91) as a software element.

The wearer management DB 91 is a database for managing information on a care-receiver targeted for the wetness detection. The target care-receiver wears the absorbable product (urine absorbing pad 50 in the above-described example) including the sensor sheet 1, and is also referred to as a wearer.

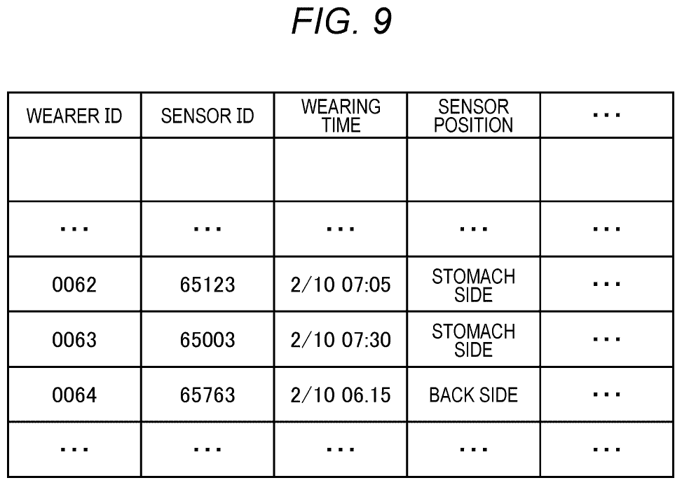

FIG. 9 shows an example of a wearer information table stored in the wearer management database 91.

As shown in FIG. 9, the wearer information table stores a record for each wearer (care-receiver), and each record stores information items such as a wearer ID, the sensor ID, a wearing time, and a sensor position. Hereinafter, these information items included in the wearer information table may be referred to as fields.

The wearer ID field stores the wearer ID which is identification information on the wearer (care-receiver). In the present system, a wearer ID unique to each wearer is assigned.

The sensor ID field stores the sensor ID of the sensor sheet 1 of the absorbable product worn by the target wearer. Thus, after the absorbable product for a certain wearer has been replaced, the data in the sensor ID field in the record including the wearer ID of such a wearer is updated to a sensor ID of the replaced sensor sheet 1.

The wearing time field stores information on the date and time when the wearer has worn the absorbable product corresponding to the sensor ID stored in the sensor ID field or information on the date and time when the absorbable product for the target wearer has been replaced.

The sensor position field stores information indicating the position of the sensor device 10 of the sensor sheet 1 on the absorbable product worn by the target wearer.

As described above, in the sensor sheet 1, the sensor device 10 is provided not below the crotch of the wearer, but in the region closer to the end portion of the sensor sheet 1 in the longitudinal direction. Thus, when the sensor sheet 1 is attached to the absorbable product (urine absorbing pad 50) as in the example shown in FIG. 1, the sensor device 10 is located on the stomach side of the wearer. On the other hand, when the sensor sheet 1 is attached to the absorbable product in the direction opposite to that of the example of FIG. 1, the sensor device 10 is located on the back side of the wearer.

When the sensor sheet 1 is formed separately from the absorbable product and an operation of attaching the sensor sheet 1 to the absorbable product is required, the position of the sensor device 10 of the sensor sheet 1 relative to the absorbable product is not always constant. This is also due to the fact that the outer shape of the sensor sheet 1 is the substantially rectangular shape as described above.

Thus, the sensor position field stores, as the information indicating the position of the sensor device 10 of the sensor sheet 1 on the absorbable product, information from which it is identifiable whether the sensor device 10 is located on the stomach side or the back side.

As shown in FIG. 8, the user terminal 70 has, e.g., a communication processing section 81, a determination section 82, an information management section 83, and a display processing section 84. Each of these software elements (processing modules) is implemented, for example, in such a manner that a computer program stored in the memory 72 is executed by the CPU 71. The computer program may be installed from a portable recording medium such as a memory card or other computers on the network via the communication device 75, and may be stored in the memory 72.

Note that some or all of the communication processing section 81, the determination section 82, the information management section 83, and the display processing section 84 may be configured as hardware elements integrally with the CPU 71 in the user terminal 70, or may be configured separately from the CPU 71.

The communication processing section 81 wirelessly communicates with the RFID reader 60 via the communication device 75. The communication processing section 81 can receive the sensor ID transmitted from the RFID reader 60. When the RFID reader 60 transmits the no-response information, the communication processing section 81 can also receive the no-response information.

Further, the communication processing section 81 may transmit, to the RFID reader 60, an instruction signal for outputting the RFID tag radio wave. In this case, when the communication processing section 81 cannot receive the sensor ID transmitted from the RFID reader 60 even after a lapse of predetermined time from transmission of the instruction signal to the RFID reader 60, the communication processing section 81 may generate the no-response information.

With the above-described configuration, in the present embodiment, the communication processing section 81 of the user terminal 70 and the RFID reader 60 are equivalent to a terminal communication section (communication processor) that wirelessly communicates with the sensor device 10 of the sensor sheet 1. Note that the terminal communication section may include the communication device 75.

The determination section 82 determines the wetness of the absorbable product according to the state of the wireless communication between the terminal communication section and the sensor device 10 of the sensor sheet 1. In the present embodiment, the communication processing section 81 receives the sensor ID or the no-response information transmitted from the RFID reader 60, and the determination section 82 determines the wetness of the absorbable product based on the sensor ID or the no-response information. The determination section 82 is equivalent to a determinator that determines the wetness of the absorbable product according to the state of the wireless communication between the communication processor and the sensor device 10.

When the RFID reader 60 outputs a radio wave to the sensor device 10 and the sensor device 10 makes a predetermined response to the RFID reader 60, the determination section 82 determines that the absorbable product is not wet. When the RFID reader 60 outputs a radio wave to the sensor device 10 and the sensor device 10 makes no predetermined response to the RFID reader 60, the determination section 82 determines that the absorbable product is wet.

The case where the predetermined response is made is, for example, a case where the sensor ID transmitted from the sensor device 10 is received by the RFID reader 60. The case where no predetermined response is made is, for example, a case where the RFID reader 60 cannot receive the sensor ID or the intensity of the received radio wave is lower than the predetermined threshold and is a case where the determination section 82 has received the no-response information transmitted from the RFID reader 60. The case where the determination section 82 has received the no-response information indicates that the state of the wireless communication between the user terminal 70 and the sensor device 10 is a specific wireless communication state corresponding to the disconnection state of the antenna portion 11 or the conductive wiring portion 13.

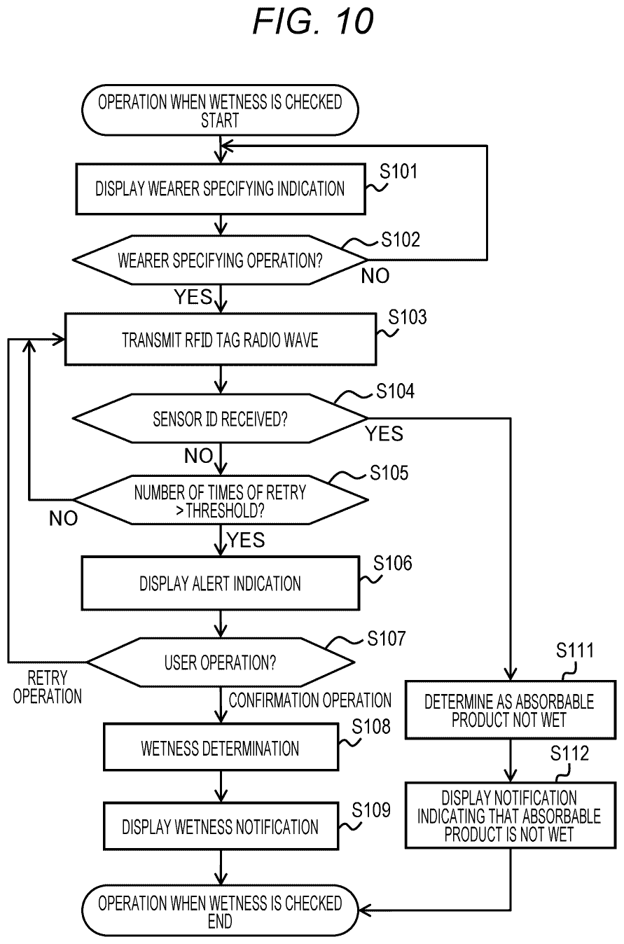

Note that in the present embodiment, as described later, even in a case where the determination section 82 has received the no-response information, it is configured such that the wetness is not determined only based on the reception of the no-response information, but is determined after processing for suppressing erroneous determination has been performed. An example shown in FIG. 10 as described later is one example of operation of the present system including such processing.

Specifically, the determination section 82 holds a wearer ID and a sensor ID of the currently-specified wearer, and when receiving a sensor ID transmitted from the RFID reader 60, the determination section 82 checks the received sensor ID against the held sensor ID for the currently-specified wearer. When both of the sensor IDs match each other, the determination section 82 determines that the absorbable product is not wet.

Note that when both of the sensor IDs do not match each other, it is considered that wireless communication with the sensor device 10 of an unintended sensor sheet 1 is made, and therefore, the determination section 82 may instruct the display processing section 84 to display an error.

In the sensor sheet 1, there is a case where the sensor device 10 is located on the back side and a case where the sensor device 10 is located on the stomach side, with respect to the absorbable product, and therefore, when the RFID reader 60 is oriented to the back side or the stomach side different from the position of the sensor device 10, there is a probability that the RFID reader 60 transmits the no-response information although the absorbable product is not wet. Hereinafter, the no-response information transmitted in this case will be referred to as “misposition no-response information”.

The determination section 82 cannot determine whether or not the received no-response information is the misposition no-response information.

For this reason, when receiving the no-response information, the determination section 82 notifies the display processing section 84 of such reception. That is, at a stage when the determination section 82 has received the no-response information, the determination section 82 notifies the display processing section 84 of the reception of the no-response information, i.e., the wireless communication state is a specific wireless communication state, without determining that the absorbable product is wet.

In response to the notification from the determination section 82, the display processing section 84 displays, on the display device 73, an alert indication about a relationship between the position of the RFID reader 60 (specifically, antenna) and the position of the sensor device 10, relative to the absorbable product. Note that details of the alert indication will be described later.

In this case, the determination section 82 determines the wetness of the absorbable product according to user operation in response to the displayed alert indication. Specifically, when specific operation is performed in response to the alert indication, the determination section 82 determines that the absorbable product gets wet. The determination section 82 may be configured, when operation different from the specific operation is performed in response to the alert indication, to wait for re-reception of the sensor ID or the no-response information without determining the wetness.

As described above, even when the determination section 82 has received the no-response information, it is possible to suppress erroneous detection of the wetness by temporarily keeping the determination on hold without immediately performing determination on the wetness and displaying an alert indication, e.g., asking the user to check the position of the RFID reader 60. In this manner, erroneous detection of the wetness can be reduced.

Here, the “determination on the wetness” of the absorbable product means that it is determined that the absorbable product including the sensor sheet 1 having the sensor ID is wet.

The information management section 83 can access the wearer management DB 91 in the server apparatus 90 by the wireless communication via the communication device 75. The wearer management DB 91 (server apparatus 90) has a function as an information storage section of the present system.

The information management section 83 reflects a sensor ID, wearing date-and-time information, and sensor position information stored in the sensor sheet 1 on the wearer information table in the wearer management DB 91 when the care-receiver wears (including replacement) the absorbable product including such a sensor sheet 1. Specifically, the information management section 83 identifies the wearer ID of the target wearer (care-receiver) when the absorbable product is worn (including replacement), acquires the sensor ID from the RFID reader 60 via the communication processing section 81, and sets the newly-acquired sensor ID, the wearing date-and-time information corresponding thereto, and the positional information (back side or stomach side) of the sensor device 10 on the absorbable product to the sensor ID field, the wearing time field, and the sensor position field in the record stored in the wearer information table and including the identified wearer ID.

As described above, according to the present system, not only the sensor ID of the worn sensor sheet 1 and the wearing time thereof but also the positional information of the sensor device 10 on the absorbable product are managed for each wearer. By presenting the positional information of the sensor device 10, an error in the position and orientation of pointing the RFID reader 60 can be suppressed, and erroneous detection of the wetness of the absorbable product can be suppressed.

The display processing section 84 controls the display device 73 to perform various types of display processing.

Specifically, the display processing section 84 causes the display device 73 to display the above-described alert indication.

The alert indication is an indication of alerting the user about the relationship between the position of the RFID reader 60 and the position of the sensor device 10, relative to the absorbable product. For example, the alert indication includes a message “the sensor may be attached to one of the back side or the stomach side opposite to an expected attachment side, and would you like to change the position of the reader and read the position again?”. Further, the alert indication includes, in addition to the message, a “confirm” operation button and a “retry” operation button.

As the user operation in response to the alert indication, the determination section 82 determines that the absorbable product is wet when the “confirm” operation button is pressed (specific operation described above). When the “retry” operation button is pressed, the determination section 82 does not make the determination on the wetness of the absorbable product, and waits for re-reception of the sensor ID or the no-response information.

The display processing section 84 causes the display device 73 to display a notification of a result of the wetness determination made by the determination section 82.

The display processing section 84 causes the display device 73 to display a wearer specifying indication for identifying the wearer ID of the care-receiver (wearer) when the care-receiver is made to wear (including replacement) the absorbable product equipped with the sensor sheet 1 and when the wetness of the absorbable product is checked.

The wearer specifying indication includes, for example, a wearer list generated based on the wearer information table in the wearer management DB 91, and an operation of specifying one wearer from the list can be performed. An operation of searching one wearer from the wearer list by inputting the name of the wearer may also be performed.

When the user operation is performed in response to the wearer specifying indication, the display processing section 84 identifies a wearer ID of a specified wearer and a sensor ID associated with the wearer ID, and causes the determination section 82 to hold these IDs as currently-specified wearer ID and sensor ID. Moreover, the display processing section 84 notifies the information management section 83 of the specified wearer ID as the wearer ID of the target wearer.

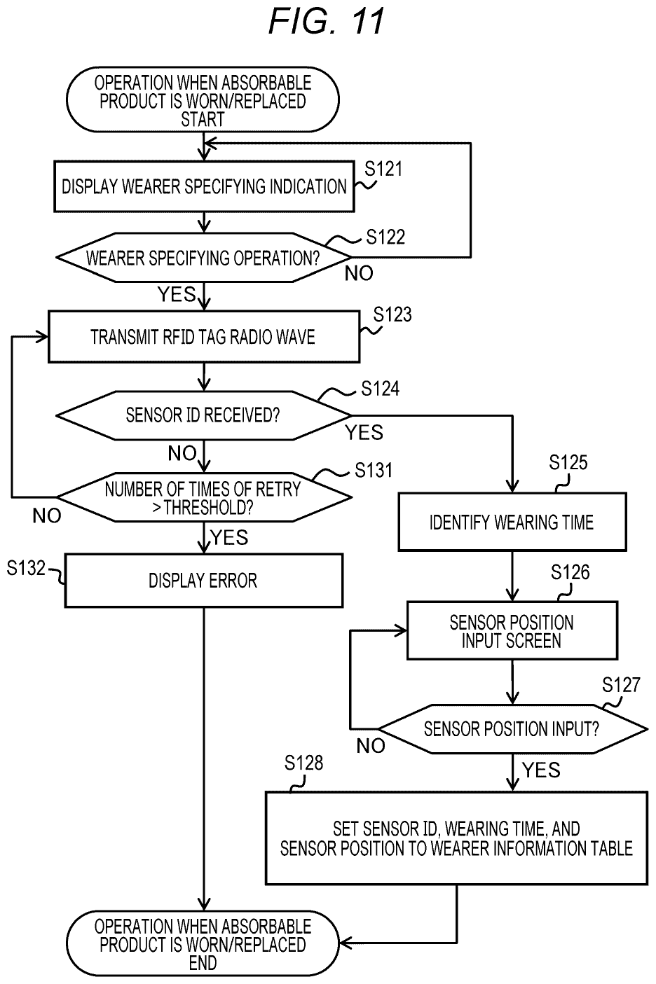

Hereinafter, an operation example of the wetness detection system will be described with reference to FIGS. 10 and 11.

FIG. 10 is a flowchart showing an operation example of the wetness detection system when the wetness is checked, and FIG. 11 is a flowchart showing an operation example of the wetness detection system when the absorbable product is worn or replaced.

First, the operation of the wetness detection system when the wetness is checked will be described with reference to FIG. 10.

In the user terminal 70, the display processing section 84 causes the display device 73 to display a wearer specifying indication (S101). As described above, the wearer specifying indication includes a wearer list, and the user operation of specifying one wearer from the wearer list can be performed.

When the wearer specifying operation is performed in response to the wearer specifying indication (S102; YES), the display processing section 84 identifies the wearer ID of the specified wearer and the sensor ID corresponding thereto based on the wearer information table in the wearer management DB 91, and causes the determination section 82 to hold these IDs.

Subsequently, the RFID reader 60 transmits an RFID tag radio wave via the antenna (S103). The RFID reader 60 may transmit the RFID tag radio wave with reception of an instruction signal from the user terminal 70 as a trigger, or may transmit the RFID tag radio wave with the user operation on the operation button of the RFID reader 60 as a trigger. Alternatively, the RFID reader 60 may periodically transmit the RFID tag radio wave without such a trigger.

When the sensor device 10 (communication portion 15) of the sensor sheet 1 is not in contact with liquid and is normally operable, the RFID reader 60 can receive a radio wave output from the sensor device 10 and can acquire the sensor ID from the radio wave. On the other hand, when the antenna portion 11 or the conductive wiring portion 13 is brought into the disconnection state due to contact of the sensor device 10 with liquid, the RFID reader 60 cannot acquire the sensor ID.

When the RFID reader 60 has successfully received the sensor ID, the RFID reader 60 transmits the sensor ID to the user terminal 70, and the communication processing section 81 of the user terminal 70 receives the sensor ID (S104; YES). On the other hand, when the RFID reader 60 cannot receive the sensor ID, the RFID reader 60 transmits the RFID tag radio wave again (S103) until the number of times of retry exceeds a threshold (S105). When the RFID reader 60 cannot receive the sensor ID until the number of times of retry exceeds the threshold (S104; NO, S105; YES), the RFID reader 60 transmits no-response information to the user terminal 70, and the communication processing section 81 receives the no-response information.

When the communication processing section 81 receives the sensor ID, the determination section 82 determines that the absorbable product for the specified wearer is not wet (S111). Then, the display processing section 84 causes the display device 73 to display a notification indicating that the absorbable product is not wet (S112).

Here, the determination section 82 may be configured, when the sensor ID has been received, to check the received sensor ID against the held sensor ID for the currently-specified wearer (not shown). In this case, the determination section 82 may be configured to determine that the absorbable product is not wet when both of the sensor IDs match each other (S111), and may be configured to instruct, without making the wetness determination, the display processing section 84 to display an error on the display device 73 when both of the sensor IDs do not match each other.

With this configuration, erroneous determination can be suppressed when the sensor ID is acquired from the sensor device 10 of an unintended sensor sheet 1 different from the sensor sheet 1 attached to the absorbable product for the specified wearer.

When the communication processing section 81 receives the no-response information, the determination section 82 notifies the display processing section 84 of such reception. Accordingly, the display processing section 84 causes the display device 73 to display the alert indication (S106).

As described above, the alert indication is an indication of alerting the user about a relationship between the position of the RFID reader 60 and the position of the sensor device 10, relative to the absorbable product, and for example, includes a “confirm” operation button and a “retry” operation button.

When a pressing operation on the “confirm” operation button (confirmation operation) is executed by the user, the determination section 82 makes the “determination on the wetness” of the absorbable product (S108), and the display processing section 84 causes the display device 73 to display a notification indicating that the absorbable product for the specified wearer is wet (S109).

On the other hand, when a pressing operation on the “retry” operation button (retry operation) is executed by the user, the determination section 82 waits for re-reception of the sensor ID or the no-response information without determining the wetness (S103). At this time, the determination section 82 may be configured to instruct, via the communication processing section 81, the RFID reader 60 to transmit the RFID tag radio wave.

As described above, according to the present system, when the sensor ID cannot be acquired from the sensor device 10, the alert indication is displayed to alert the carer who is the user, e.g., about whether or not the reading position of the RFID reader 60 is proper, and in this manner, erroneously determining as the absorbable product being wet although the absorbable product is not wet is suppressed.

Next, the operation of the present system when the absorbable product is worn or replaced will be described with reference to FIG. 11.

In this case as well, in the user terminal 70, the display processing section 84 causes the display device 73 to display the wearer specifying indication (S121). The wearer specifying indication is as described above.

When the wearer specifying operation is performed in response to the wearer specifying indication (S122; YES), the display processing section 84 identifies the wearer ID of the specified wearer based on a wearer information table in the wearer management DB 91, and causes the information management section 83 to hold the wearer ID.

Subsequently, the RFID reader 60 transmits the RFID tag radio wave via the antenna (S123). The RFID reader 60 may transmit the RFID tag radio wave with reception of an instruction signal from the user terminal 70 as a trigger, or may transmit the RFID tag radio wave with the user operation on the operation button of the RFID reader 60 as a trigger. Alternatively, the RFID reader 60 may periodically transmit the RFID tag radio wave without such a trigger.

In this case, the absorbable product including the sensor sheet 1 is in a new state before worn, and the RFID reader 60 can be placed sufficiently close to the sensor sheet 1. Thus, normally, the RFID reader 60 can receive a radio wave output from the sensor device 10, and the sensor ID can be acquired from the radio wave (S124; YES). The RFID reader 60 transmits the received sensor ID to the user terminal 70.

Note that in, e.g., a case where there is some kind of defect in the sensor device 10, the RFID reader 60 may not be able to receive the sensor ID (S124; NO). In this case, the RFID reader 60 transmits the RFID tag radio wave (S123) until the number of times of retry exceeds the threshold (S131). When the sensor ID cannot be received until the number of times of retry exceeds the threshold (S124; NO, S131; YES), the RFID reader 60 transmits the no-response information to the user terminal 70, and the communication processing section 81 receives the no-response information. Accordingly, the display processing section 84 causes the display device 73 to display the error (S132).

When the communication processing section 81 receives the sensor ID, the information management section 83 acquires the sensor ID and identifies the time of such acquisition as a wearing time (S125), and the display processing section 84 causes the display device 73 to display a sensor position input screen (S126). This input screen is a display screen asking the user to specify whether the position of the sensor device 10 relative to the absorbable product is on the stomach side or the back side.

When the positional information of the sensor device 10 is input (specified) by the user operation on the input screen (S127; YES), the information management section 83 sets the received sensor ID, the wearing time identified in (S125), and the input positional information of the sensor device 10 to the record in a wearer information table, which is identified by the wearer ID of the specified wearer (S128).

As described above, according to the present system, not only the sensor ID of the worn sensor sheet 1 and the wearing time thereof but also the positional information of the sensor device 10 on the absorbable product are managed for each wearer when the absorbable product is worn or replaced. By presenting the positional information of the sensor device 10 in this manner, an error in the position and orientation of pointing the RFID reader 60 can be suppressed, and erroneous detection of the wetness of the absorbable product can be suppressed.

FIGS. 10 and 11 show a plurality of steps in a sequential order, but the order of execution of the steps is not limited to that of the example shown in the figure, but changes can be made as necessary without departing from the gist.

### Modifications

The content of the above-described embodiment is one example, and therefore, may be partially modified as necessary.

For example, in the above-described wetness detection system, the RFID reader 60 and the user terminal 70 are separately formed, and are configured to be capable of wireless communication with each other. However, the RFID reader 60 and the user terminal 70 may be implemented as one apparatus (hardware). In this case, the user terminal 70 includes an antenna, and is capable of transmitting and receiving the RFID tag radio wave.

Further, the RFID reader 60 may be implemented not as a mobile type but as a stationary type.

Further, in the above-described wetness detection system, an example where the user terminal 70 includes the determination section 82 has been described, but the server apparatus 90 may include the determination section 82 and the user terminal 70 may mainly include the display processing section 84.

Furthermore, in the above-described wetness detection system, the example where the plurality of care-receivers (wearers) is targeted has been described, but one wearer may be targeted. In this case, the wearer management DB 91 and the server apparatus 90 are not required, and the wearer specifying processing is not required either.

Some or all of the above-described embodiment and modifications may be identified as follows. Note that the above-described embodiment and modifications are not limited to the description below.
<1> A wetness detection sensor sheet, the wetness detection sensor sheet being configured to be worn as part of an absorbable product by a wearer or be worn together with the absorbable product by the wearer, including: a sheet-shaped sensor device; and a water-conducting sheet, in which
the sensor device includes an antenna portion and a communication portion, and is configured to be capable of wireless communication;
the water-conducting sheet is placed on one or both sides of the sensor device in an overlapping manner, and is configured to extend from a stomach side to a back side through below a crotch of the wearer when the wearer wears the absorbable product; and
the sensor device is provided on a side closer to a region of the water-conducting sheet corresponding to the stomach side or a region of the water-conducting sheet corresponding to the back side with respect to a region of the water-conducting sheet corresponding to below the crotch.
<2> The wetness detection sensor sheet according to <1>, further including: a first water-permeable sheet; a second water-permeable sheet; and a slip-proof sheet, in which
the sensor device and the water-conducting sheet are provided between the first water-permeable sheet and the second water-permeable sheet, and in plan view, are provided so as to be included in the first water-permeable sheet and the second water-permeable sheet;
the slip-proof sheet is provided on a surface of the first water-permeable sheet or the second water-permeable sheet opposite to the sensor device and the water-conducting sheet, and is configured to suppress misalignment of the wetness detection sensor sheet relative to the absorbable product; and
the slip-proof sheet has such a size that a region where the slip-proof sheet and the sensor device overlap with each other in plan view occupies over a half of an entirety of the slip-proof sheet.
<3> The wetness detection sensor sheet according to <2>, in which the slip-proof sheet is provided so as to be included in the sensor device in plan view.
<4> The wetness detection sensor sheet according to any one of <1> to <3>, further including: a water-absorbing member placed between the water-conducting sheet and the sensor device, in which the sensor device further includes a conductive wiring portion connecting the communication portion and the antenna portion, and the antenna portion or the conductive wiring portion is brought into a disconnection state according to a water-absorbing state of the water-absorbing member.
<5> A wetness detection sensor sheet set including:
a plurality of the wetness detection sensor sheets according to <4>, in which the water-absorbing members of the plurality of the wetness detection sensor sheets included in the wetness detection sensor sheet set are each configured to have a different amount of water absorption at which the antenna portion or the conductive wiring portion of the sensor device is brought into the disconnection state.
<6> A wetness detection system configured to be capable of wireless communication with the wetness detection sensor sheet according to <4>, including: a terminal communication section; a determination section; a display processing section; and a display device, in which
the terminal communication section includes an antenna, and is configured to be capable of wireless communication with the sensor device via the antenna;
the determination section is configured to determine wetness of the absorbable product according to a wireless communication state between the terminal communication section and the sensor device;
when the wireless communication state indicates a specific wireless communication state corresponding to the disconnection state of the sensor device, the display processing section causes the display device to display an alert indication about a relationship between a position of the antenna and a position of the sensor device, relative to the absorbable product, and
the determination section determines the wetness of the absorbable product according to user operation in response to the alert indication.
<7> A wetness detection system configured to be capable of wireless communication with the wetness detection sensor sheet according to <4>, including: a terminal communication section; a determination section; an information management section; and an information storage section, in which
the terminal communication section is configured to be capable of wireless communication with the sensor device;
the determination section is configured to determine wetness of the absorbable product according to a wireless communication state between the terminal communication section and the sensor device,
the information storage section is configured to store wearer identification information, wearing time information, sensor identification information, and positional information of the sensor device on the absorbable product for each wearer of the absorbable product,
the sensor device has sensor identification information,
the terminal communication section is configured to be capable of acquiring the sensor identification information from the sensor device via the wireless communication, and
when the absorbable product is worn, the information management section identifies the wearer identification information on a wearer specified by user operation, causes the terminal communication section to acquire the sensor identification information from the sensor device, and stores, in the information storage section, the acquired sensor identification information, the wearing time information, and the positional information of the sensor device on the absorbable product in association with the identified wearer identification information.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is;:

1. A wetness detection sensor sheet,
the wetness detection sensor sheet being configured to be worn as part of an absorbable product by a wearer or be worn together with the absorbable product by the wearer, comprising:
a sheet-shaped sensor device; and
a water-conducting sheet,
wherein the sensor device includes an antenna portion and a communication portion, and is configured to be capable of wireless communication,
the water-conducting sheet is placed on one or both sides of the sensor device in an overlapping manner, and is configured to extend from a stomach side to a back side through below a crotch of the wearer when the wearer wears the absorbable product, and
the sensor device is provided on a side closer to a region of the water-conducting sheet corresponding to the stomach side or a region of the water-conducting sheet corresponding to the back side with respect to a region of the water-conducting sheet corresponding to below the crotch.

2. The wetness detection sensor sheet according to claim 1, further comprising:
a first water-permeable sheet;
a second water-permeable sheet; and
a slip-proof sheet,
wherein the sensor device and the water-conducting sheet are provided between the first water-permeable sheet and the second water-permeable sheet, and in plan view, are provided so as to be included in the first water-permeable sheet and the second water-permeable sheet,
the slip-proof sheet is provided on a surface of the first water-permeable sheet or the second water-permeable sheet opposite to the sensor device and the water-conducting sheet, and is configured to suppress misalignment of the wetness detection sensor sheet relative to the absorbable product, and
the slip-proof sheet has such a size that a region where the slip-proof sheet and the sensor device overlap with each other in plan view occupies over a half of an entirety of the slip-proof sheet.

3. The wetness detection sensor sheet according to claim 2, wherein
the slip-proof sheet is provided so as to be included in the sensor device in plan view.

4. The wetness detection sensor sheet according to claim 1, further comprising:
a water-absorbing member placed between the water-conducting sheet and the sensor device,
wherein the sensor device further includes a conductive wiring portion connecting the communication portion and the antenna portion, and
the antenna portion or the conductive wiring portion is brought into a disconnection state according to a water-absorbing state of the water-absorbing member.

5. A wetness detection sensor sheet set comprising:
a plurality of the wetness detection sensor sheets according to claim 4,
wherein the water-absorbing members of the plurality of the wetness detection sensor sheets included in the wetness detection sensor sheet set are each configured to have a different amount of water absorption at which the antenna portion or the conductive wiring portion of the sensor device is brought into the disconnection state.

6. A wetness detection system configured to be capable of wireless communication with the wetness detection sensor sheet according to claim 4, comprising:
a terminal communication section;
a determination section;
a display processing section; and
a display device,
wherein the terminal communication section includes an antenna, and is configured to be capable of wireless communication with the sensor device via the antenna,
the determination section is configured to determine wetness of the absorbable product according to a wireless communication state between the terminal communication section and the sensor device,
when the wireless communication state indicates a specific wireless communication state corresponding to the disconnection state of the sensor device, the display processing section causes the display device to display an alert indication about a relationship between a position of the antenna and a position of the sensor device, relative to the absorbable product, and
the determination section determines the wetness of the absorbable product according to user operation in response to the alert indication.

7. A wetness detection system configured to be capable of wireless communication with the wetness detection sensor sheet according to claim 4, comprising:
a terminal communication section;
a determination section;
an information management section; and
an information storage section,
wherein the terminal communication section is configured to be capable of wireless communication with the sensor device,
the determination section is configured to determine wetness of the absorbable product according to a wireless communication state between the terminal communication section and the sensor device,
the information storage section is configured to store wearer identification information, wearing time information, sensor identification information, and positional information of the sensor device on the absorbable product for each wearer of the absorbable product,
the sensor device has sensor identification information,
the terminal communication section is configured to be capable of acquiring the sensor identification information from the sensor device via the wireless communication, and
when the absorbable product is worn, the information management section identifies the wearer identification information on a wearer specified by user operation, causes the terminal communication section to acquire the sensor identification information from the sensor device, and stores, in the information storage section, the acquired sensor identification information, the wearing time information, and the positional information of the sensor device on the absorbable product in association with the identified wearer identification information.
